(19) United States
(12) Patent Application Publication
(10) Pub. No.: US 2006/0137178 A1
(43) Pub. Date: Jun. 29, 2006

(54) Wire wrapper

(76) Inventor: Kevin Larkin, Pebble Beach, CA (US)

Correspondence Address: STALLMAN & POLLOCK LLP, 353 SACRAMENTO STREET, SUITE 2200, SAN FRANCISCO, CA, 94111, US

(21) Appl. No.: 11/021,960

(22) Filed: Dec. 23, 2004

(51) Int. Cl. B23P 19/00

(52) U.S. Cl. 29/758; 29/745; 29/750

(57) ABSTRACT

The lubrication process for a wire wrap hand tool can be improved by including a lubrication mechanism in the tool housing. In one such tool, the lubrication mechanism is an opening positioned in the housing that allows the needle portion of a syringe to pass into the housing near a moveable component of the drive assembly of the tool. The syringe then can dispense an appropriate amount of lubricant in order to properly lubricate the component(s) of the drive assembly without having to disassemble the tool. This approach can prevent the loss or contamination of parts internal to the tool, while preventing a loss of productivity due to the disassembly and reassembly of the tool.

### TECHNICAL FIELD OF THE INVENTION

The present invention relates to hand tools for creating wrapped wire connections.

### BACKGROUND

Wire wrapping is a common approach to creating electrical connections for devices and components in the telecommunications and electronics fields. In such a connection, an end of a wire that has been at least partially stripped of insulation is tightly wound around a post member, in order to create a quality solderless connection that provides good electrical contact between the wire and the post. Wire wrapping has been shown to be a reliable connection method, making connections both quickly and efficiently. Many hand tools have been developed to facilitate the creation of these wire wrap connections, such as electric power tools and manually turnable tools. For applications such as telecommunications, a typical wire wrap tool is a squeeze-type tool, which includes a handle with a trigger mechanism. The wire wrap tool utilizes a wrapping bit containing an opening, recess, or groove for receiving an end of the wire to be wrapped. Upon activation of the tool, the bit rotates such that the wire is wrapped around the post forming a wrap connection.

One problem with wire wrap hand tools is that it becomes necessary from time to time to oil the gears, bearings, and/or motion transfer devices inside the tool housing that are used as part of the drive assembly. This typically requires taking apart the housing, which takes time and reduces productivity. Further, it is then necessary to properly align the components of the drive assembly while closing the case, which oftentimes can be rather difficult. It is occasionally necessary to take the tool apart a second or third time and reassemble the tool to correct an improper assembly. Further, the tool can include many small parts that can be lost or contaminated during lubrication and assembly, especially when the assembly is done in the field.

### BRIEF DESCRIPTION OF THE DRAWINGS

FIG. 1 is a (a) perspective view and (b) top view diagram of a wire wrap tool housing that can be used in accordance with one embodiment of the present invention.

FIG. 2 is a cross-section of the housing of FIG. 1, including a trigger mechanism, collet-style chuck, and wrapping bit.

FIG. 3 is a perspective view of (a) the bit of FIG. 2 for accepting a wire and post member, and (b) the post member after having the wire wrapped about.

FIG. 4 shows a portion of the cross-section of FIG. 2, including a syringe passed through an opening in the housing in order to lubricate the inner drive mechanism in accordance with one embodiment of the present invention.

### DETAILED DESCRIPTION

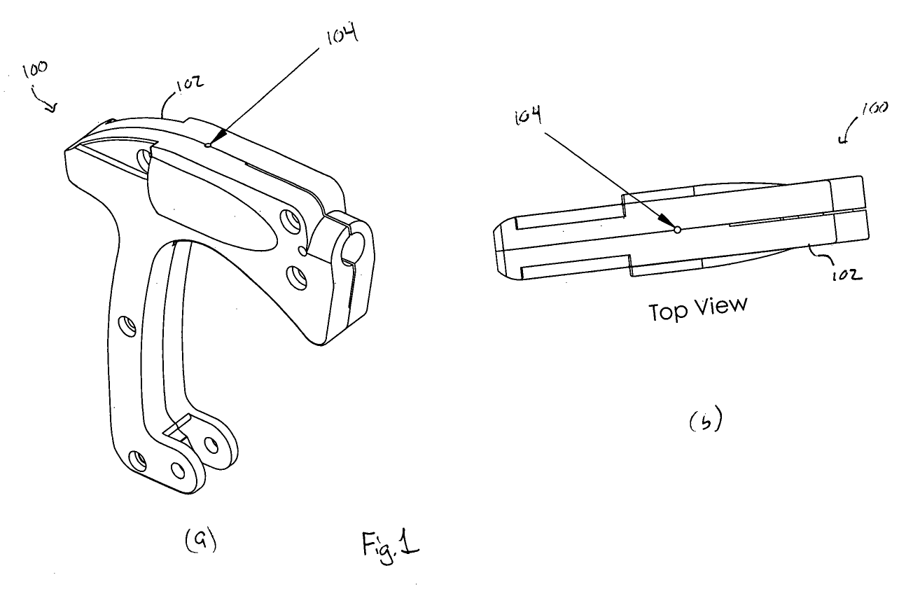

Systems and methods in accordance with various embodiments of the present invention can overcome these and other deficiencies in existing wire wrap tools by providing a lubrication mechanism in the tool 100 itself. As shown in FIG. 1, this lubrication mechanism can take the form of an opening 104 in the casing 102 at an appropriate location, and of a sufficient dimension, to allow a syringe or other lubrication-delivery device (shown in FIG. 4) to reach that portion of the drive assembly without need to disassemble the tool. In various embodiments, components of the drive assembly can be heat-treated and/or coated in order to prevent wear and corrosion and to minimize the need for lubrication. However, it still can be necessary to occasionally lubricate the drive assembly in order to ensure proper operation.

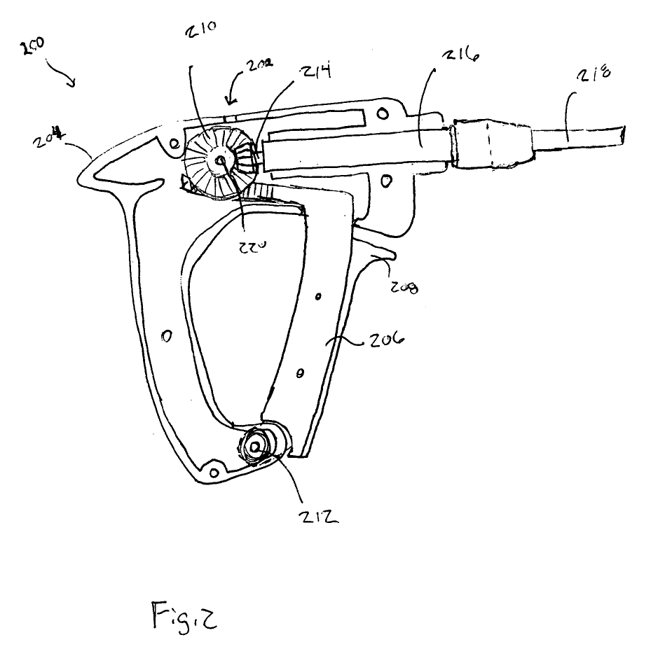

In one example, the wire wrap tool 200 shown in FIG. 2 has a trigger mechanism 206 allowing a user to activate the tool by squeezing a trigger member relative to a handle portion of the housing 204. The housing and trigger member can be made of any appropriate material, such as for example a durable metal such as aluminum or a high-impact, lightweight plastic such as lexan polycarbonate, and can be shaped to fit comfortably in the hand of a user. The housing also can be insulated and/or coated with a non-conductive material. The trigger member can be pivotably connected to the housing through a pivot connection 212, such as a bearing or rod assembly that holds the trigger mechanism and housing in contact while allowing a lever motion of the trigger mechanism. At least one grip-facilitating member 208 can be added to the trigger mechanism and/or handle portion of the housing in order to aid in properly positioning the tool in the hand of a user. The trigger member 206 is in moveable contact with the drive assembly, which in this embodiment includes a main drive gear 210. The contact can be made directly or through any of a number of motion transfer methods known and/or used in the art, such as gears, pulleys, wires, and bearings. As the end of the trigger member 206 is squeezed by a user, the near-linear motion of the trigger member 206 is transferred to a rotation of the main drive gear 210. The size of the housing can limit the range of motion of the trigger mechanism, such that there will be a maximum number of possible rotations of the main drive gear 210 for each pull of the trigger mechanism 206. By properly selecting the range of motion of the trigger member, the size of the main gear, and the corresponding motion transfer connection, it is possible to set a desired number of rotations of the main drive gear for each full squeeze of the trigger mechanism.

The main drive gear 210 in this embodiment is in moveable contact with a drive actuator 214. The drive actuator 214 has a head portion forming a gear that can interact with the main drive gear 210 such that a rotation of the main drive gear 210 in the plane of the figure results in a rotation of the drive actuator 214 in a plane orthogonal to the plane of the figure. Methods of shaping and connecting gear assemblies for transferring rotation between two orthogonal planes are well known in the art. The gear ratio can be set such that the number of maximum possible rotations of the main drive gear 210 results in a desired maximum number of rotations of the drive actuator 214. The desired number of rotations can vary by application, but for a typical wire wrap application can involve ten total revolutions.

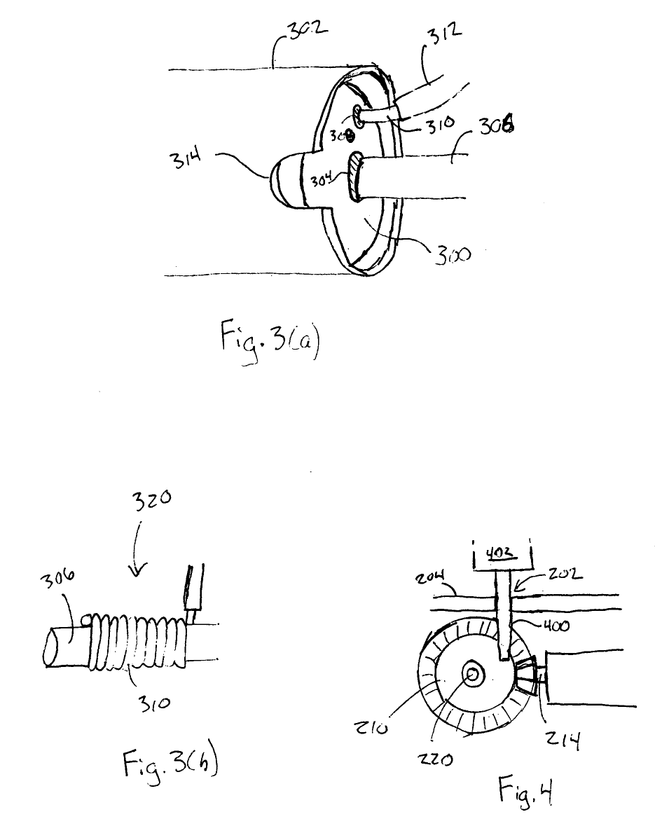

The operable end of the drive actuator 214 can be in contact with a chuck member 216, such as a collet-style chuck member, which is capable of accepting and firmly holding a wrapping bit 218. A collet-style chuck can be used that allows for easy installation and removal of industry standard bits and sleeves. The chuck in one embodiment can accept any of a number of industry standard bits, such as a 3″ wire wrap bit that can accept wire in gauge from 24-34 AWG (American Wire Gauge standard). The bit also can have an outer sleeve for protecting a user from the rotating bit 218. The bit 218 can be used to wrap the wire around a pin, post, or terminal, as will be described in detail with respect to FIG. 3. While a manual trigger mechanism is discussed herein for exemplary purposes, it should be understood that advantages of the various embodiments of the present invention can be obtained for other rotational drive mechanisms as well, such as for tools with electric motors or that utilize battery power as known and used in the art. Any moveable part, connection, or interface of the various drive mechanisms which typically requires lubrication can be addressed using any of the approaches discussed herein.

While a design such as that shown in FIG. 2 can be simple and easy to use, it can be desirable to maintain the rotational capability of the main drive gear 210 and the actuator 214 of the drive assembly. Without proper lubrication of the main gear 210, for example, the gear can lock up or catch during operation. This can be problematic, as the wire wrap tool can cease to function, or can at least fail to provide a smooth, consistent rotation of the wrapping bit 218. Inconsistent rotation of the wrapping bit can cause the individual windings of the resultant wrap connection to have varying tension and/or position, which can lessen the strength of the connection.

Using existing approaches, it would be necessary to open the housing 210 periodically lubricate at least some of the moveable parts of the drive assembly, such as the main gear 210. When re-assembling the housing, it then would be necessary to ensure proper alignment and contact of the main gear 210, drive actuator 214, and trigger mechanism 206 while closing the housing. This can be difficult, as it typically is not possible to hold the parts in place as the housing is closed due to the fact that the fingers of a user or a positioning tool will not fit into a closed or almost-closed housing. Any shifting of the parts while the housing is being closed can result in an inoperable tool, such that it is necessary to take apart and re-assemble the tool. This can be especially difficult in the field, where there may be no good work surfaces and the small parts of the tool, such as the main gear, can fall out of the housing and easily be lost or covered in dirt and debris.

In order to minimize or eliminate the need to disassemble the housing 210 for purposes of lubrication, a lubrication mechanism can be provided in the tool that allows any gears, actuators, or other moveable parts in the tool to be lubricated inside the housing 204. A simple approach is shown in the exemplary device of FIG. 2. Here, the lubrication mechanism takes the form of an opening 202 in the housing 204. The opening is positioned in the housing at a proper location, and of sufficient dimension, such that a syringe (shown in FIG. 4) or other lubrication delivery device can be passed at least partially into the housing to a point near at least one of the parts to be lubricated. The opening 202 in the housing 204 of FIG. 2 allows lubrication to be supplied near the main drive gear 210. Properly lubricating the drive gear 210 not only helps the gear to rotate freely about the central gear rod 220, but also can facilitate the motion transfer between the teeth of the gear 210 and the trigger mechanism 206, as well as between the gear 210 and the drive actuator 214. Depending on the drive mechanism used for the tool, the number of moving parts, and the design of the tool, it can be desirable to include additional openings or lubrication ports in the housing 204 of the tool. These additional openings can be of a sufficient dimension and at a reasonable position in the housing such that a lubrication tool such as a syringe can pass through the opening and can reach the part(s) to be lubricated. Each opening should not be too large, as a large opening can allow dirt and debris to enter the housing, and can allow the syringe to pass at an increasing number of angles into the housing, such that the lubricant might not be delivered to the appropriate location.

The opening 202 can have associated with it a plug 222 or other device for sealing the opening when not in use. Such a plug can prevent debris from entering the housing, and can prevent any lubricant leakage. The opening also can have associated with it an amount of tubing, grooves, or other lubricant-directing mechanism capable of directing the lubricant to a desired location. For instance, tubing from the opening to near the central rod 220 of the main gear 210 can allow lubricant to be fairly precisely directed to the desired location, without having to carefully position the syringe inside the housing. Further, preventing the syringe from passing too far into the housing can prevent the syringe from contacting and/or displacing any of the components inside the housing.

It should be understood that there can be many other appropriate approaches to lubricating the inner drive mechanism of a wire wrap tool without disassembling the tool. For instance, a small plastic or metal door can be placed on the housing. The door can be opened to allow a syringe or nozzle to be passed into the housing in order to lubricate the desired components. The door then can be closed and latched or snapped into place after lubrication. Adding a door, however, can add cost and complexity to the device, and is can be an additional concern for future wear. Other approaches also can be used, such as any flap, membrane, orifice, or moveable member that allows a lubricating device to pass into the housing in order to lubricate at least one moveable part of the tool.

FIG. 3(a) shows the operable end of an exemplary bit 300 that can be used with a wire wrap tool as described with respect to FIGS. 1 and 2. The bit is shown inside a protective outer sleeve 302 that can protect a user from the rotating bit 300. As can be seen, this bit has a larger center hole 304 capable of receiving a pin or post 306 to which a wire wrap connection is to be made. The center hole can be of any appropriate diameter, such as a diameter capable of accepting a 0.025 inch square wire post. The center hole is approximately centered about the rotational axis of the bit, such that the bit can rotate about the post when wrapping the wire, thereby stabilizing the position of the bit relative to the post. This stabilized position can be necessary in order to maintain a consistent tension on the wire. This bit also contains a smaller offset hole 308 for receiving an end of the wire 310 to be wrapped. The wire can be any appropriate gauge wire, such as for example 18-34 AWG gauge wire. The wire also can be any appropriate wire, such as annealed copper or copper alloy wire. The wire can be insulated or non-insulated, depending upon the application. For insulated wire, the insulation 312 can be stripped such that the entire portion of the wire that is inserted into the offset hole 308 is bare of insulation. For modified wraps, a portion of the insulation can remain on the part of the wire that is inserted in the offset hole, in order to allow a number of windings of the wire wrap, such as on the order of ½ to 1½ windings, to contain insulation. Leaving at least part of a winding insulated can help the connection withstand vibration. After the stripped end of the wire is placed into the offset hole, the center hole of the bit can be positioned over the post 306.

The sleeve 302 can have a recess area 314 that is slightly larger than the outer circumference of the wire 310, including any insulation 312, such that the sleeve can be pressed tight against the board or device containing the post 304 to be connected if desired. In many embodiments, however, the height of the post will determine the “resting” location of the bit. The ability to press the sleeve tight against the board can help to reach and maintain the desired position for the wire wrap. The sleeve also allows only the weight of the tool to be applied to the connection, such that the tool does all the work of wrapping the wire. The recess also can be extended a distance away from the end of the bit such that the wire initially crosses the post 306 at the desired location of the initial winding of the wire wrap. In this way, the rotating of the bit causes the wire to spiral upward around the post from the initial location, being slowly and tightly pulled from the offset hole, such that a tight spiral wire wrap is created about the post. An exemplary wire wrap connection 320 is shown in FIG. 3(b), where the wire has been successfully wrapped around the post 306. During the wrapping process, a relatively consistent amount of tension can be applied to the wire as the wire is pulled from the offset hole by the rotation of the bit. This tension can cause the wire to stretch as the wire is wrapped around the post 306. Although a circular post is shown in FIG. 3(b), a post having relatively sharp edges, such as a square post, can be used to improve the strength of the connection. When the post has such edges, the edges can press into the outer surface of the wire, thereby resisting any tendency of the wire to uncurl. Each edge of the post can cut a notch in the wire, and/or can become at least slightly deformed about the wire. Further, some tension will remain in the wire after wrapping, causing the wire to effectively grip the edges or corners of the post. Allowing the post to press into the wire can increase the amount of surface area in contact between the post and the wire. As shown in the Figure, it can be desirable to have as little bare wire extending away from post as possible, in order to protect the electrical components at either end of the wire.

FIG. 4 shows a portion of the cross-section of FIG. 2, carrying over reference numbers where appropriate for simplicity. The needle portion 400 of a syringe 402 is shown to be passed through the opening 202 of the housing 204. The opening can be shaped such that the needle portion passes substantially orthogonal to the local surface of the housing 204, and can be dimensioned such that the needle portion passes at most a predetermined distance into the housing. Although an orthogonal orientation is shown, it should be understood that the opening can be angled in order to direct the needle portion at an angle, where necessary due to the design of the tool. The needle portion 400 is shown to extend to a location such that the lubricant will be applied to the main gear 210, between the center rod 220 about which the gear turns and the head portion of the drive actuator 214. In such a design, the trigger mechanism can be squeezed during the dispensation of the lubricant, in order to spread the lubricant about the gear 210. Rotating the gear while dispensing also can help to lubricate the interface between the teeth of the gear and the teeth of the drive actuator, as well as to lubricate the center rod of the gear. When requiring a disassembly of the housing for lubrication, it typically is impossible to squeeze the trigger mechanism in order to spread the lubricant. The lubricant used can be any appropriate lubricant known and/or used in the art. The syringe or lubricant dispensing device can be any appropriate device known or used for dispensing such a lubricant. The selection of the syringe can depend upon any of a number of factors, such as the design of the tool and the amount of lubrication needed. It is also possible to use a tube of lubricant, where the tube has an appropriate nozzle device for dispensation.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A hand tool for making a wire wrap connection, comprising:
a tool housing having a handle portion and an operable end portion;
a trigger mechanism pivotably attached to the handle portion;
a main drive gear positioned inside the tool housing such that pivoting of the trigger mechanism causes a rotation of the main drive gear;
a drive actuator in contact with the main drive gear in the housing and capable of rotationally driving a wrapping bit placed at the operable end of the housing, the drive actuator having a gear portion shaped to mate with the main drive gear whereby rotation of the main drive gear causes a rotation of the drive actuator; and
an opening in the tool housing for allowing an end of a lubricant dispensing device to pass into the housing, the opening being aligned with at least one of the main drive gear and drive actuator, whereby lubricant can be applied to at least one of the main drive gear and drive actuator without opening the tool housing.

2. A hand tool according to claim 1, further comprising:
a plug for mating with said opening in order to prevent debris from entering the housing, the plug being removable in order to allow the lubricant dispensing device to pass through the opening.

3. A hand tool according to claim 1, wherein:
the lubricant dispensing device is a syringe having a needle portion capable of at least partially passing through the opening and into the housing in order to apply lubricant to at least one of the main drive gear and drive actuator.

4. A hand tool according to claim 1, further comprising:
at least one additional opening in the tool housing for allowing an end of the lubricant dispensing device to apply lubricant to at least one of the main drive gear and drive actuator.

5. A hand tool according to claim 1, further comprising:
a wrapping bit for receiving an end of a wire to be wrapped, the bit capable of wrapping the wire around a post member when rotationally driven by the drive actuator.

6. A hand tool according to claim 5, further comprising:
a sleeve for surrounding the bit.

7. A hand tool according to claim 5, further comprising:
a chuck mechanism for contacting the drive actuator and rotationally holding the bit at the operable end of the housing.

8. A hand tool for making a wire wrap connection, comprising:
a tool housing having a handle portion and an operable end portion;
a drive assembly inside the tool housing for rotationally driving a wrapping bit placed at the operable end of the housing;
means for activating said drive assembly; and
a lubrication mechanism allowing at least one component of the drive assembly to be lubricated without opening the tool housing.
